(19) United States
(12) Patent Application Publication
(10) Pub. No.: US 2009/0224418 A1
(43) Pub. Date: Sep. 10, 2009

(54) Method and device for the production of polyethylene terephthalate preforms

(76) Inventors: Geraldine Rames-Langlade, Viroflay (FR); Yves Benjamin, Hayange Marspich (FR)

Correspondence Address: AIR LIQUIDE;Intellectual Property, 2700 POST OAK BOULEVARD, SUITE 1800, HOUSTON, TX, 77056, US

(21) Appl. No.: 10/557,499

(22) PCT Filed: May 7, 2004
(86) PCT No.: PCT/FR04/01123

§ 371 Date: Feb. 26, 2008

(30) Foreign Application Priority Data
May 21, 2003 (FR) 03/06085

(51) Int. Cl. B29C 45/18; B29C 47/10

(52) U.S. Cl. 264/85

(57) ABSTRACT

The invention relates to a method and device for the production of polyethylene terephthalate preforms. The inventive device comprises: a feed hopper (3) for polymer granules arriving from a dryer; means (1, 2) for heating, moving and pressurising the polymer, such as a heated screw conveyor; and polymer-shaping means. According to the invention, an inert gas is injected at a point (4, 5, etc.) which is located at the dryer, at the hopper or downstream of the hopper, said gas being pre-heated to a temperature of at least 170 DEG C. and, preferably, within a temperature range of between 170 DEG C. and 250 DEG C.

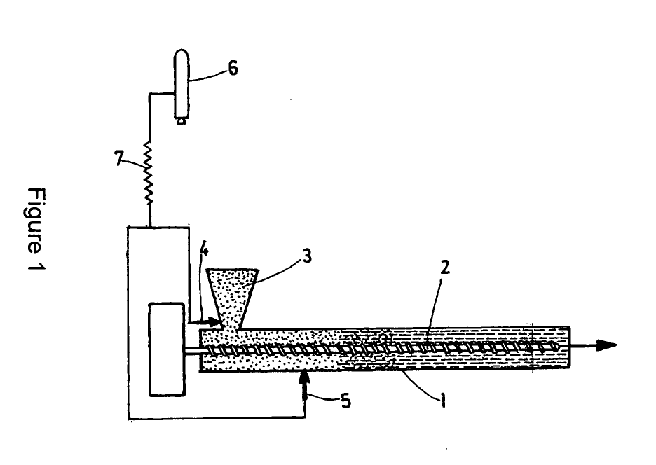

The present invention relates to the field of the production of objects of polyethylene terephthalate (PET), particularly of bottles for packaging beverages such as mineral water, carbonated beverages, still beverages, alcohol-free beverages, or oils. In fact, PET, in addition to its optical properties (very good transparency and brightness) and mechanical properties (impact strength, internal pressure resistance), has advantages from the environmental stand point (biodegradable materials and the possibility of recycling) and at the commercial level (weight, production cost, ease of production). Thus, the use of PET for bottles is tending to grow steadily (its use was estimated at 5 million tonnes in 1999, expected to rise to 7 million tonnes in 2004 and 10 million tonnes in 2010).

Extrusion or injection molding of plastic is a known method that consists in melting a polymer and feeding the molten polymer continuously into a die or injection head in order to form it. This method generally makes use of:
a polymer feed hopper, in which the polymer is introduced in powder or granule form (from a dryer),
means for transporting, heating and mixing, and also pressurizing the polymer issuing from the hopper, conventionally a heated screw conveyor,
means for forming the molten polymer (most commonly comprising a die head for producing profiles or sheets, or a mold for producing three-dimensional objects).

It is known that during this type of method, and particularly the melting step in the screw conveyor, some polymers may be sensitive to the presence of oxygen, which degrades the final properties of the formed plastic (yellowing, crosslinking of the polymer, variation in the molecular weight and in the viscosity).

In fact, it is a well known fact that PET is a polymer subject to degradation. The degradation reactions occur under the action of temperature, oxygen in the air, moisture, or mechanical stresses. These reactions can take place during the various steps occurring in the manufacture of such bottles (PET production, PET processing into granules, granule storage and drying, PET processing into preforms, and into bottles) but also during the use of the bottle as a beverage storage receptacle.

The various studies conducted in the literature on the degradation of PET show that these reactions cause a decrease in the viscosity of the PET, a deterioration of its mechanical properties, an increase in the acidity (a sign of PET degradation), yellowing of the material, etc., as well as the formation of volatile organic compounds. Owing to the composition of the PET, and due to the operating conditions employed, these volatile organic compounds are chiefly acetaldehyde, formaldehyde and carbon monoxide. These compounds, and particularly acetaldehyde, are formed in the PET when it is in the form of granules, preforms or even bottles, and diffuse in the material to the point of migrating into the water or the beverage contained in these bottles. The formation of acetaldehyde from PET has been described in the literature. This compound is formed during thermal degradation in the presence of oxygen (thermo-oxidative degradation) and also in the absence of oxygen (thermal degradation). The presence of moisture accelerates the PET degradation process and therefore increases the formation of acetaldehyde. In fact, water can act in two ways: either it reacts directly with one of the degradation by-products formed by thermal or thermo-oxidative degradation to yield acetaldehyde, or it degrades the PET by forming an acid and an alcohol, the latter also reacting with said degradation by-products to form acetaldehyde. The formation of formaldehyde, also a toxic compound, is not described in the literature as precisely as that of acetaldehyde, but its formation can be assumed to follow similar reaction paths.

In fact, it is known that the presence of acetaldehyde, with a very low olfactory and organoleptic threshold for man (typically 0.01 ppb in air and 20 μg/l in water), imparts a “sugary plastic” taste that is unpleasant for consumers. This taste is further accentuated in mineral water because of the absence of masking agents or products that are commonly used in beverages such as fruit juices, sodas, etc. Moreover, acetaldehyde, exposed to air is unstable and, by oxidation or polymerization, leads to by-products such as acetic acid. Thus, independently of sensory considerations, the toxicity of acetaldehyde and of the by-products formed, particularly carcinogenic activity, also raises a concern for public health, even if the concentrations of these substances remain low.

Owing to the fact that a few traces of acetaldehyde are capable of affecting the organoleptic properties, the storage of mineral water and of any type of beverage in PET bottles is therefore critical. It is therefore indispensable to limit the degradation of the PET in order to reduce the formation of degradation products and of acetaldehyde in particular.

The problem that the invention proposes to solve is to reduce the formation of acetaldehyde from PET and more specifically during the forming of PET into preforms. The PET granules are formed by injection molding: the PET granules are melted in a screw extruder heated to between 260° C. and 310° C. before injection into the mold.

Several solutions for reducing the formation of acetaldehyde from a PET preform have been described in the literature.

A first solution consists in adding a stabilizer to the PET. This stabilizer present in the PET granules acts during its processing into a preform by injection molding. This stabilizer serves to reduce the proportion of acetaldehyde formed either by minimizing the degradation reactions that take place under the action of the temperature and the air, or by reacting directly with the acetaldehyde as it is formed in order to convert it.

For example, document U.S. Pat. No. 5,922,828 relates to the use of a novel stabilizer of the phosphite type. This stabilizer has the primary function of destroying the degradation by-products formed from the oxygen in the air (compounds of the hydroperoxide type) and liable to accelerate this very type of degradation. Thus, the presence of a stabilizer of the phosphite type in the preparation of the PET serves to reduce the degradation due to oxygen, so that the acetaldehyde content induced by the forming step is also reduced.

Reference can also be made to documents U.S. Pat. No. 6,191,209 and EP 1 239 006 in the name of Ciba Speciality Chemistry, which relate to the use of stabilizers to reduce the formation of acetaldehyde. These stabilizers are either copolymers of vinyl alcohol and ethylene, or organic compounds such as amine hydroxyls, amine oxides, nitrones, etc.

This first solution, which consists in the use of stabilizers, has drawbacks such as the cost of the products, their toxicity, their application, which may be difficult, because they may not be miscible with the PET or may be sensitive to water, and their use, because their presence engenders parametric changes in the operation of the screw, etc.

A second solution consists in exposing PET preforms to a carbon dioxide atmosphere. This solution is reported in document U.S. Pat. No. 4,764,323, which shows that the exposure of PET preforms to carbon dioxide under certain pressure and temperature conditions leads to a reduction of the proportion of acetaldehyde formed. The manufactured PET preforms are placed in an autoclave at a pressure of 50 to 100 bar and are subjected to a stream of CO₂ vapor heated to between 25° C. and 90° C. The treatment time is 5 minutes to 10 hours, depending on the pressure and temperature applied. Even though this solution yields satisfactory results in terms of acetaldehyde reduction, it appears difficult to implement this batch process under industrial conditions, in which the production of preforms is continuous and reaches up to 50 000 preforms per hour.

Finally, a third solution consists of removing the oxygen from the air present in the zone in which the PET processing takes place and in replacing this oxygen by an inert gas such as nitrogen. In fact, the removal of oxygen serves to reduce the degradation of the PET due to oxygen and hence to reduce the formation of acetaldehyde caused by this degradation. Document U.S. Pat. No. 4,142,040 describes a PET processing method in which an inert gas such as nitrogen is introduced downstream of the hopper feeding the screw extruder with granules (at the transition between the hopper and the screw or within the screw itself). Thus, the atmosphere in contact with the molten PET at about 300° C. is depleted in oxygen, thereby minimizing the degradation resulting from the presence of oxygen and, in consequence, the quantity of acetaldehyde formed. For example, at 300° C. (temperature used to melt the PET), the quantity of acetaldehyde measured in an atmosphere containing 0% oxygen is 3.4 ppm, whereas it is 20 ppm in an atmosphere containing 10% oxygen. Contrary to the other solutions proposed, this solution is easy to implement, economic and environmentally friendly.

Comparative tests of PET degradation in atmospheres of nitrogen (M. Dzieciol et al, Journal of Applied Polymer Science, 77, 1894 (2000)) and air (M. Dzieciol et al, Journal of Applied Polymer Science, 69, 2377 (1998)) have demonstrated that the use of nitrogen serves to reduce the acetaldehyde content and also the formaldehyde content, as well as the carbon monoxide content.

This solution of nitrogen injection is therefore highly advantageous but insufficient to reduce the acetaldehyde content measured in the preform to below 2 ppm, as specified by the food standards currently being prepared by the profession, or indeed below 1.5 ppm in the future.

The problem that the invention proposes to solve is accordingly to reduce the formation of acetaldehyde from PET and more specifically during the forming of the PET into a preform in proportions such that the acetaldehyde content in the preforms can be lower than 1.5 ppm.

According to the invention, an inert gas, such as nitrogen, previously preheated to a temperature of at least 170° C., is injected downstream of the feed hopper, preferably in the granule feed zone of the screw extruder (i.e. substantially in the transition zone between hopper and screw) or even within the screw extruder itself.

The limit of 170° C. has been selected to take account of the fact that the granules upstream of the hopper issue from the dryer at a temperature close to 180° C.

In the case of injection in the granule feed zone of the screw extruder, the invention allows the creation of a zone free not only of oxygen but also of moisture. Hence the PET, before being introduced into the screw extruder and being heated to the melt state, is neither in contact with oxygen nor with moisture.

It has been demonstrated that the injection of nitrogen at ambient temperature serves to reduce the formation of acetaldehyde by limiting the degradation reactions due to the presence of oxygen. The injection of hot nitrogen should therefore serve to limit the problems of degradation associated with the presence of oxygen, as well as those associated with the presence of moisture, as explained previously.

Moreover, the use of hot nitrogen should also serve to increase the temperature of the PET granules before they enter the screw without damaging it, thereby reducing the amount of energy required during plasticization, energy that is partly provided by mechanical stress.

By simultaneously limiting the degradation of PET due to oxygen, due to moisture, and due to mechanical stresses, the formation of acetaldehyde should be reduced commensurately.

This will be demonstrated below in greater detail by the experimental results.

In comparison with existing solutions, the injection of hot inert gas has the following advantages:
the solution remains less costly than the use of stabilizers or exposure to carbon dioxide, even accounting for the cost of the energy required to preheat the gas,
it is easy to implement,
it does not cause the formation of toxic by-products,
it is more efficient in terms of reducing acetaldehyde, because it serves to reduce the acetaldehyde formation reactions due to oxygen, due to the presence of moisture, or even to mechanical stresses.

The invention accordingly relates to a method for producing objects of polyethylene terephthalate (PET), particularly of preforms for packaging beverages, which comprises:
a hopper for feeding polymer granules issuing from a dryer,
polymer heating, conveying and pressurizing means, such as a heated screw conveyor,
means for forming the molten polymer, and in which an inert gas is injected at a point located at one or more of the following locations;
at the dryer;
at the hopper;
downstream of the hopper; the gas being preheated, before its injection at said location, to a temperature of at least 170° C., preferably in the temperature range from 170° C. to 250° C.

The method according to the invention can also adopt one or more of the following characteristics:
said gas injection is carried out in the polymer feed zone of said heating, conveying and pressurizing means i.e. substantially in the transition zone between the hopper and said heating, conveying and pressurizing means;
said gas injection is carried out in said heating, conveying and pressurizing means, in what is called the plasticizing/melting zone;
the gas injection is carried out with a flow rate of between 5 and 20 Sm³/h.

The invention further relates to a device for producing objects of polyethylene terephthalate (PET), particularly preforms for packaging beverages, said device comprising:
a hopper for feeding polymer granules issuing from a dryer,
polymer heating, conveying and pressurizing means, such as a heated screw conveyor,
means for forming the molten polymer, and
at least one means for injecting inert gas at a point located at the dryer, or at the hopper, or downstream of the hopper,
   characterized in that it comprises means for preheating the gas, before its injection at said location, to a temperature of at least 170° C.

Other features and advantages will appear from the following description, provided only as an example and with reference to the single FIGURE appended hereto, which is a schematic view of a unit according to the invention.

The FIGURE shows the extruder 1, equipped with a screw 2, fed with polymer granules via the hopper 3. It should be noted that the FIGURE shows a conventional hopper of frustoconical shape (the most common shape) but also that in certain industrial installations, the screw is fed with polymer via a “hopper” that very simply takes the form of a pipe or column, which obviously must not be considered as being outside the scope of the present invention.

The FIGURE shows an embodiment of the invention in which a preheated inert gas is injected downstream of the hopper, at two locations, taken alone or in combination:
injection 4 in the transition zone between hopper and extruder;
injection 5 in the upstream portion of the screw.

As will clearly appear to a person skilled in the art, the injection must preferably take place at a location where the granules are still solid, considering that such a screw typically comprises three zones:
the feed zone supplying the screw with granules (which are undeniably solid there);
the plasticizing/melting zone in which solid and molten granules coexist;
the pumping zone (where the granules are molten) that pressurizes the polymer in order to make it pass through the die.

The gas issues from a source 6 and transits before injection via a preheating means 7, for example a resistance heater or a pipe wrapped with a heating tape.

Understandably, the preheating means should be positioned as close as possible to the injection point or points.

As demonstrated below by examples of application, excellent results have been obtained on an installation like the one shown in this FIGURE, using a 610 kg/h Husky injection molding machine (reference: P100/110 E 120).

This molding machine is used to produce preforms of PET bottles. The PET granules, previously dried in air for 6 hours at about 170° C., are introduced directly (via a “straight hopper” as indicated previously) into the screw extruder via a sealed line. The granules, introduced into a screw conveyor, are heated to temperatures of between 260° C. and 310° C. depending on the zone of the screw. The PET in the melt state is then injected into an injection molding machine for producing 48 preforms.

A single nitrogen injection (at position 4) is employed for these tests, and for this purpose, the line for feeding the screw with granules was equipped with a gas injector like the one described in document WO 02/22342 in the name of the Applicant. This injector allows nitrogen to be injected, perpendicular to the granule flow, under laminar and uniform conditions, into the feed line. The injector was also equipped with a thermocouple to measure the gas temperature at the injection point.

The injected gas was preheated beforehand using a heating strip wound around the gas line connected to the injector.

The flow rate of nitrogen, in a purity of at least 99.9%, was controlled by a flowmeter.

The acetaldehyde content of the preform at a given position in the mold was determined by gas chromatography, a technique commonly used in this application.

The results obtained in these operating conditions are given in the table below, which shows the acetaldehyde content obtained as a function of each operating condition. It should be noted that the gas flow rate is not constant in the table, because it had to be decreased in order to reach temperatures in the range of 170° C.

For certain tests, stabilizers were added at a position downstream of the nitrogen injection.

The results demonstrate the following points:
nitrogen injection serves to obtain a lower acetaldehyde content than that obtained without nitrogen injection,
the example in row 3 in the table shows the comparative results obtained with unpreheated gas (in fact, the zone in question is naturally at a higher temperature than ambient temperature, the gas there having been measured at 40° C.) and they are observably insufficient and clearly less favorable than if the gas is preheated,
the hot gas injection decreases the amount of acetaldehyde formed and the acetaldehyde content is lower with higher gas temperature,
at 170° C., under nitrogen, the reduction of acetaldehyde is 46% in comparison with air,
the use of 0.06% of stabilizers sharply reduces the acetaldehyde content (from 2.19 to 0.77 ppm) but the additional presence of nitrogen serves to reduce the quantity of stabilizers by about half (penultimate line of the table). The table also clearly shows that this addition of stabilizers could be discarded completely while remaining within the content limits set.

| | Nitrogen | | | |
|---|---|---|---|---|
| | flow | Injection | | Acetaldehyde |
| Nitrogen | rate | temperature | Stabilizer | content |
| injection | (Nm³/h) | (° C.) | (%) | (ppm) |
| No | — | — | 0 | 2.19 |
| No | — | — | 0.06 | 0.77 |
| Yes | 12 | 40 | 0 | 1.5 |
| Yes | 12 | 140 | 0 | 1.4 |
| Yes | 8 | 160 | 0 | 1.25 |
| Yes | 6 | 170 | 0 | 1.19 |
| Yes | 6 | 170 | 0.03 | 0.85 |

The advantages of the invention in terms or reducing the acetaldehyde content formed has been particularly demonstrated in the preceding discussion, but it is important to recall the fact that during the forming of polyethylene terephthalate in ambient air, the polyethylene terephthalate undergoes degradation of the thermo-oxidative type. In fact, subjected to heat, to mechanical stresses and to the presence of oxygen in the air, PET is degraded to form by-products such as acetaldehyde. The mechanism of acetaldehyde formation in the presence of oxygen derives from the removal of a hydrogen atom from the CH₂ group of the PET.

If the hydrogen atom is removed from the aromatic ring, the radical formed on the aromatic ring reacts with the oxygen and, via a free radical mechanism, leads to the formation of by-products such as 2-hydroxy phenyl ester and to the semi-quinone and quinone groups.

These species are known to strongly absorb ultraviolet light at 340 nm for 2-hyroxyphenyl ester and between 400 and 450 nm for the semi-quinone and quinone groups. It is the absorption of UV light in the zones defined above that causes the yellowing of PET.

The forming of PET in a substantially oxygen-free atmosphere according to the present invention therefore serves to limit the formation of these by-products that are responsible for yellowing.

1-6. (canceled)

7. A method for producing objects of polyethylene terephthalate (PET), particularly of preforms for packaging beverages, which comprises:
a hopper for feeding polymer granules issuing from a dryer,
polymer heating, conveying and pressurizing means, such as a heated screw conveyor,
means for forming the molten polymer,
and in which an inert gas is injected at a point located at one or more of the following locations;
at the dryer;
at the hopper;
downstream of the hopper;
the gas being preheated, before its injection at said location, to a temperature of at least 170° C., preferably in the temperature range from 170° C. to 250° C.

8. The method for producing objects of claim 7, characterized in that said gas injection is carried out in the polymer feed zone of said heating, conveying and pressurizing means i.e. substantially in the transition zone between the hopper and said heating, conveying and pressurizing means.

9. The method for producing objects of claim 7, characterized in that said gas injection is carried out in said heating, conveying and pressurizing means, in what is called the plasticizing/melting zone.

10. The method for producing objects of claim 7, characterized in that said gas injection is carried out with a flow rate of between 5 and 20 Nm³/h.

11. The method for producing objects of claim 7, characterized in that the acetaldehyde content of the preform thus produced is lower than the content of preforms that would be obtained in comparable operating conditions but in which the injected inert gas is not preheated.

12. A device for producing objects of polyethylene terephthalate (PET), particularly bottles for packaging beverages, said device comprising:
a hopper (3) for feeding polymer granules issuing from a dryer,
polymer heating, conveying and pressurizing means (1, 2), such as a heated screw conveyor,
means for forming the molten polymer, and
at least one means (4, 5) for injecting inert gas at a point located at the dryer, or at the hopper, or downstream of the hopper,
characterized in that it comprises means (7) for preheating the gas, before its injection at said location, to a temperature of at least 170° C., preferably in the temperature range from 170° C. to 250° C.
